(19) United States
(12) Patent Application Publication
(10) Pub. No.: US 2008/0307531 A1
(43) Pub. Date: Dec. 11, 2008

(54) Method for Optimizing Reconfiguration Processes in Mobile Radio Network Having Reconfigurable Terminals

(76) Inventors: Rainer Falk, Eching (DE); Eiman Bushra Mohyeldin, Munchen (DE); Christoph Niedermeier, Munchen (DE); Reiner Schmid, Munchen (DE)

Correspondence Address: STAAS & HALSEY LLP, SUITE 700, 1201 NEW YORK AVENUE, N.W., WASHINGTON, DC, 20005, US

(21) Appl. No.: 11/597,584

(22) PCT Filed: May 23, 2005
(86) PCT No.: PCT/EP05/52344

§ 371 Date: Nov. 27, 2006

(30) Foreign Application Priority Data
May 28, 2004 (DE) 102 004 025 734.5

(51) Int. Cl. G06F 21/00

(52) U.S. Cl. 726/27

(57) ABSTRACT

Access-protected memory zones in network elements are localized in an operator's network that supporting the reconfiguration of SDR terminals in combination with protected data transmission methods which include methods for authenticating and authorizing the communication partners and for communicating in a protected manner, especially to protect integrity and confidentiality. Such access-protected data is provided by the terminal and is transmitted to the radio access network in the framework of negotiations and is temporarily stored therein or is generated directly in the RAN in the framework of processes related to the terminal. The generation and management of access-protected memory zones by the network operator result in a massive relief of the load to which the air interface is subject while also significantly alleviating the network infrastructure with regard to signaling.

### CROSS REFERENCE TO RELATED APPLICATIONS

This application is based on and hereby claims priority to German Application No. 10 2004 025 734.5 filed on May 26, 2004, the contents of which are hereby incorporated by reference.

### BACKGROUND

A method is disclosed for optimizing reconfiguration processes in mobile radio networks with reconfigurable terminals, within the framework of which technical equipment of the mobile radio operator obtains measurement data regarding the behavior of the mobile terminal, summarizes it and makes it available to third parties for evaluation, with reconfigurable terminals referring to those mobile radio devices in which in particular a new radio technology not previously supported by the device is utilized by exchanging software which configures the transceiver of the terminal.

Future mobile radio networks will integrate different radio technologies and thus offer users the option of selecting the technology best suited for use with the specific application context in each case. This requires a far greater outlay on the part of the mobile radio terminal, also referred to below as the terminal, by comparison with known technology in respect of the capabilities or number of built-in radio transceivers. To keep power consumption, weight, size and manufacturing costs of terminals within sensible limits the use of a single universally-reconfigurable transceiver is preferred, for which different radio technologies can be implemented in software. The technology underlying this concept is called Software Defined Radio (SDR).

Characteristics of SDR terminals will not be completely standardized, since the manufacturers do not wish to divulge specific know-how and, for an SDR terminal to function correctly, it is only necessary to adhere to the radio standard as well as the communication protocol, but not to know about internal characteristics. These types of characteristics, such as the energy consumption of specific radio modes for example, the time required for reconfiguration or the size of the software needed for a new mode which must be loaded under some circumstances by a server into the terminal before it can be reconfigured, are however not to be accessible to all partners involved in the operation of the mobile radio network as well as the application services provided. In particular inspection of such information by competing manufacturers is to be prevented. However specific parties involved are to be given controlled access to selected states and characteristics of the terminal.

Although data encryption can be employed to guarantee more secure communication between the relevant terminal and the person with authorized access, this communication connection is however undertaken via the radio interface and thus reduces the bandwidth available for applications.

### SUMMARY

An aspect lies in specifying a method of optimizing reconfiguration processes in mobile radio networks with reconfigurable terminals and of specifying a corresponding system in which data which relates to reconfigurable terminals is made available by the network operator or by the relevant device manufacturer in a way in which the load on the radio interface can be relieved and also as regards the signaling in a way in which the load on the network infrastructure can be relieved.

A particular aspect is access-protected memory areas on network elements localized in the network of an operator supporting the reconfiguration of SDR terminals in combination with methods for protected data transmission which preferably relate to mechanisms for authentication and authorization of the communication partners as well as for protected communication, especially the protection of integrity and confidentiality. This type of access-protected data originates either from the terminal and is transmitted as part of the negotiations to the Radio Access Network (RAN) and is buffered there, or it is generated within the context of processes related to the terminal directly in the RAN. A further important aspect lies in the generation and administration of access-protected memory areas in the network. This advantageously leads to a reduction in the load on the radio interface and also, in respect of the signaling, to a reduction in the load on the network infrastructure.

### BRIEF DESCRIPTION OF THE DRAWINGS

These and other objects and advantages will become more apparent and more readily appreciated from the following description of exemplary embodiments, taken in conjunction with the accompanying drawings of which:

FIG. 1 is a block diagram to explain a first exemplary embodiment; and

FIG. 2 is a block diagram to explain the second exemplary embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

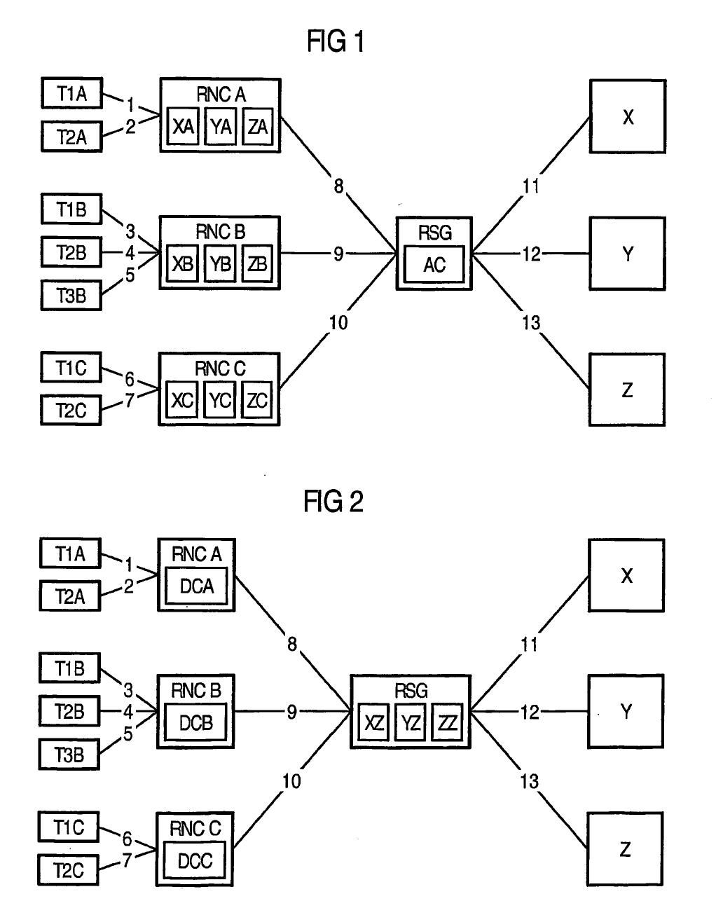

FIG. 1 shows a diagram to explain a first exemplary embodiment with access-protected memory areas XA, YA and ZA in a Radio Network Controller) RNCA, with respective access-protected memory areas XB, YB and ZB in a radio network controller RNCB and with respective access-protected memory areas XC, YC and ZC in a radio network controller RNCC, with the network element RNCA being connected in the example to two terminals T1A and T2A, network element RNCB to three terminals T1B, T2B and T3B and network element RNCB to two terminals T1C and T2C. The network elements RNCA, RNCB and RNCC are connected or are able to be connected to a further network element in the shape of what is known as a Reconfiguration Service Gateway RGS, with this further network element featuring an access control device AC and being connected or being able to be connected to terminal manufacturers X, Y and/or service providers Z.

The access-protected memory areas for the authorized access parties X, Y and Z are also set up in each case on the RNCs in the Radio Access Network (RAN). Each RNC stores data relating to terminals registered with it locally. The access control AC is responsible for the registration of parties with authorized access and also for accepting access requests and executes the required authentication methods and, if these are successful, forwards access requests to the RNCs, which are responsible for data encryption and sending the data to the parties with authorized access.

This first embodiment provides especially good scalability since access-protected memory areas are set up distributed and, when the mobile radio network is expanded, the number of units which can accommodate access-protected memory areas grows along with the expansion.

FIG. 2 shows a diagram to explain a second exemplary embodiment, with this exemplary embodiment essentially being distinguished from the first exemplary embodiment by the access-protected memory areas XZ, YZ and ZZ for the authorized access parties X, Y and Z being set up here centrally on the RSG or AC (not shown) in what is known as the core network of the mobile radio network. The network elements RNCA, RNCB and RNCC each contain a data collector DCA, DCB and DCC and transmit data generated by them or originating from the terminal to the access control device AC. By contrast with the first exemplary embodiment, this is not only responsible for the registration of authorized access parties and the acceptance of access requests but also for the encryption and sending of the data to a server of the authorized access party. This embodiment is based on central storage of the data which places all authorized access party storage areas on the AC. If the mobile radio network is expanded the access control AC must therefore be scaled accordingly to enable it to handle the greater volumes of data arising.

A significant part of the data of interest is not stored in the terminal but occurs in the Radio Access Network (RAN), such as measurement data for example which has been obtained by measuring the quality of the radio bearer or the timing sequence of vertical handovers between two radio technologies. In addition data of the terminal generated in the terminal may possibly be needed in the RAN in any event.

To implement the required controlled access to the data technical precautions on the network unit are especially required which grant authorized access parties direct access to data stored there but deny access to unauthorized parties.

Scenarios which advantageously illustrate a protected access to data stored in a network of the operator include:
a) Read access by the terminal manufacturer: Data which is generated within the framework of monitoring the behavior of the terminal during reconfiguration processes is to be made available to the manufacturer of the terminal for analyses and optimizations. Data which has been supplied by the terminal is only to be readable by the network operator with restrictions.
b) Write access by the terminal manufacturer: Terminal profiles describing the current configuration and also reconfiguration options of terminals are to be updated to the latest version for one or more identically-designed terminals, e.g. after a firmware update. The network operator is to be given access to specific parts of the terminal profile for handover decisions.
c) Write access by the terminal manufacturer: New firmware or reconfiguration software is to be loaded on the terminal in order to replace faulty software or to make possible new features, e.g. support for new radio access technologies. The software is to be certified to enable manipulations by third parties which endanger the functioning of the terminal to be detected. The terminal rejects software not correctly certified. This certification can optionally be technically implemented by a digital signature or by a cryptographically-protected checksum. Furthermore the software can optionally be encrypted to prevent third parties being aware of it.
d) Read access by the service Provider: Data which has been generated within the framework of monitoring the behavior of application services is to be made available to the service provider for analyses and optimizations. Data which has been supplied by an application running on the terminal is only to be able to be read by the network operator with restrictions.
e) Write access by the service provider: Service profiles describing the current configuration as well as reconfiguration options are to be updated for a service. The network operator is to be given access to specific parts of the service profile for handover decisions.
f) Write access by the service provider: New application software is to be loaded into the terminal in order to replace faulty software or to make possible new features, e.g. support for new multimedia standards. The software is to be certified to enable manipulations by third parties which endanger the functioning of the application to be detected. Software not correctly certified is rejected. This certification can optionally be technically implemented by a digital signature or by a cryptographically-protected checksum. Furthermore the software can optionally be encrypted to prevent third parties being aware of it.

An important factor is the use of access-protected memory areas on a network elements localized in the network of the operator supporting the reconfiguration of SDR terminals in combination with methods for protected data transmission. These preferably include methods for authentication and authorization checking or authorization of the communication partners as well as for protected communication, especially the protection of integrity and confidentiality. This type of access-protected data originates either from the terminal and is transmitted as part of the negotiations to the Radio Access Network (RAN) and is buffered there, or it is generated within the context of processes related to the terminal directly in the RAN.

These memory areas can be physically different, i.e. the assigned address ranges are different or differ logically. It is especially possible for a number of logical memory areas or for parts thereof to be mapped to the same physical memory area. In other words a logical memory area in this case represents a specific view of one or more physical memory areas.

A further aspect lies in the generation and administration of access-protected memory areas by the network operator. The network operator generates one of these access-protected memory areas for each authorized access party. Authorized access parties are assigned to each memory area. An authorized access party is assigned credentials which are needed for the method of protected data transmission used. Credentials are especially needed for the authentication of the authorized access party as well as for safeguarding data communication. Since data which occurs and which the authorized access party would like to retrieve always originates from specific data sources, e.g. from terminals or applications services or a least is related to these, an additional authentication feature is required which makes possible the assignment of the relevant source to the access-protected memory area. This feature is agreed between network operator and authorized access party and is specified by each data source within the context of registration in the RAN together with an identity characteristic specific to the source. On the one hand this method makes possible the assignment of data sources to a specific authorized access party and thereby to their access-protected memory area, on the other hand it allows the storage of data separately for each data source.

Access to protected memory areas is undertaken in the following manner:

The authorized access party contacts a server of the network operator with which the necessary authentication, e.g. with the aid of the authentication features described above, will be executed. After the authentication is completed the authorized access party sends a request which specifies the type of desired access, i.e. which data is to be transferred, the frequency with which the data transmissions are to be undertaken and whether a one-off or periodic transmission is to be undertaken. The network operator then, in accordance with a request, sends the encrypted data to the server of the authorized access party. In a similar manner the authorized access party can optionally also write data into the access-protected memory which is included by the network operator for the reconfiguration or if necessary is transferred to the terminal, e.g. software downloads.

The primary advantage of the described method, compared to solutions in which the data is transmitted via the radio interface from terminal to a server, lies in alleviating the load on the radio interface. This relates especially to data generated by measurements in the RAN. This data which also occurs in large volumes, would, within the framework of a known method, initially have to be transferred over the radio interface to the terminal, in order to be subsequently transported over the radio interface to the server. This duplication of the load on the radio interface does not occur with the method described herein.

A further advantage lies in the fact that data to be transmitted is encrypted in the network and the terminal is thereby relieved of this task. Data from which conclusions can be drawn about internal characteristics of the terminal is particularly sensitive and may not therefore be transmitted unencrypted in the network in order to prevent unauthorized access to it. This group of data includes for example measurement data, but also terminal profiles which describe the characteristics of the terminal hardware.

Access-protected memory areas can allow write access as well as read access. This makes it possible to load data from a server into the radio access network. In such cases updates of profiles or software can be involved for which data can be loaded onto the terminal at a suitable (under some circumstances later) point in time. The storage in access-protected memory areas in the RAN permits the decoupling of data transport in the network from transport over the radio interface. Mechanism and time of the latter can be suitably selected by the network operator depending on the utilization of the RAN or of the terminal. In addition the network operator can also access the stored information himself and can use this for optimizing reconfiguration processes.

By combining data which originates from many different data sources in the one memory area assigned to authorized access parties it is also possible to request the transmission of the totality of this data or of a selected cross section within the context of a single request from the server side. With a method based on known mechanisms on the other hand. many individual interactions between the server and the different terminals are required. The method described thus also results in a significant reduction of the load on the network infrastructure in respect of signaling as well.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for control of reconfiguration processes in a mobile radio network with reconfigurable terminals, comprising:
providing at least one memory area protected against unauthorized access in at least one network element of the mobile radio network, the at least one protected memory area accessible exclusively to authorized equipment of at least one of a terminal manufacturer and a service provider for at least one of read and write access; and
storing terminal-related data, originating in each case from the reconfigurable terminals and transmitted in protected form to the network within a framework of negotiations, in the at least one protected memory area.

11. A method as claimed in claim 10, further comprising:
executing authentication for access to the access-protected memory area in response to authorization data received from the authorized equipment of the at least one of the terminal manufacturer and the service provider respectively,
sending a request specifying a type of desired access upon successful conclusion of the authentication of the authorized equipment of the at least one of the terminal manufacturer and the service provider, and
transferring at least one item of terminal-related data corresponding to the request from the at least one network element to the authorized equipment of the at least one of the terminal manufacturer and the service provider.

12. A method as claimed in claim 11, wherein the request specifies the at least one item of terminal-related data to be transmitted, a frequency of data transmission as well as information indicating which of a single and a periodic transmission is to be performed.

13. A method as specified in claim 12, wherein the terminal-related data in the at least one memory area protected against unauthorized access is reconfiguration data used for reconfiguration of the reconfigurable terminals or is transmitted to the reconfigurable terminals.

14. A system for control of reconfiguration processes of a mobile radio network supporting reconfigurable terminals, comprising:
at least one network element having at least one memory area protected against unauthorized access and storing terminal-related data originating from the reconfigurable terminals and transferred in protected form to the mobile radio network in a framework of negotiations; and
an access control device controlling at least one of read and write access to the at least one memory area by only access-protected equipment of at least one of a terminal manufacturer and a service provider.

15. A system as claimed in claim 14, wherein said access control device further performs encryption and transmission of the terminal-related data to the equipment of the at least one of the terminal manufacturer and the service provider which has been authorized.

16. A system as claimed in claim 15, wherein the at least one access-protected memory area and the access control device are implemented on a single network element.

17. A system as claimed in claim 15, wherein the at least one access-protected memory area and the access control device are implemented on different network elements.

18. A network element of a mobile radio network which supports reconfigurable terminals, comprising:
at least one memory area protected against unauthorized access and storing terminal-related data originating from the reconfigurable terminals and transferred in protected form to the mobile radio network within a framework of negotiations; and
an access control device controlling at least one of read and write access to the at least one memory area by only authorized equipment of at least one of a terminal manufacturer and a service provider.
